(19) United States
(12) Patent Application Publication
(10) Pub. No.: US 2006/0013254 A1
(43) Pub. Date: Jan. 19, 2006

(54) System and method for routing communication through various communication channel types

(76) Inventors: Oded Shmueli, Nofit (IL); Benny Yehezkel, Ramat-Gan (IL); Yosef Rockah, Kiriat-Motzkin (IL)

Correspondence Address: Martin D. Moynihan;PRTSI, Inc., P. O. Box 16423, Arlington, VA, 22215, US

(21) Appl. No.: 11/146,130

(22) Filed: Jun. 7, 2005

Related U.S. Application Data
(60) Provisional application No. 60/578,049, filed on Jun. 7, 2004.

(51) Int. Cl. H04L 12/28

(52) U.S. Cl. 370/466; 370/401

(57) ABSTRACT

A system for establishing data communication between user clients is provided. The system includes a router which is capable of automatically routing communication data through a communication channel of a plurality of communication channel types; the communication channel is selected by the router according to at least one selection parameter applied thereby.

### RELATED APPLICATION

This application claims the benefit of U.S. Provisional Patent Application No. 60/578,049 filed Jun. 7, 2004

### FIELD AND BACKGROUND OF THE INVENTION

The present invention relates to a system and method for routing communication through various communication channel types thereby enabling communication between different communication devices.

The digital revolution, and in particular cellular telephony and the internet, has changed the way people communicate and interact with personal devices. More and more people utilize cellular and computer networks to gain access to advanced communication services provided through personal computers, mobile devices, and now even games consoles (e.g., Nintendo DS or PSP). The choice of communications services available is greater than ever before. Cellular, WiMax/WiFi and satellite networks enable communication while on the move while the advent of high-speed Internet connections provides households access to a whole new range of communications services and experiences.

The ability to communicate almost anywhere, anytime, with few geographical limitations has resulted in a society that is almost always ‘connected’. Whether at home or in the office, individuals can now utilize landline phones, wireless mobile phones (e.g. cell phones), cable-based telephone services and Internet telephony based services to communicate. Individuals may use a cordless phone handset or other wireless home or office links (e.g. Wi-Fi, Bluetooth) which are not physically connected to a wall plug or wire. Telephony itself may now include video as well as audio and text (e.g., SMS or e-mail) components.

Due to the availability of numerous communication options, individuals are nowadays forced to employ several communication devices each dedicated to a particular communication channel type and each being characterized by a specific communication ID (e.g., telephone number in the case of a landline or cellular telephone), communication quality, ease of use, connectivity (geographic or otherwise) and other quality of service parameters such as connection reliability and cost. Due to the fact that each of these services can be utilized for communication, making a decision as to which service to use, especially when placing an outgoing call, can be difficult.

There is thus a widely recognized need for, and it would be highly advantageous to have, an easy-to-operate ‘universal’ device that can be utilized to communicate data, such as voice data through any type of a communication channel utilized by any type of communication device.

### SUMMARY OF THE INVENTION

According to one aspect of the present invention there is provided a system for establishing data communication between user clients comprising a router capable of automatically routing communication data through a communication channel of a plurality of communication channel types, the communication channel being selected by the router according to at least one selection parameter applied thereby.

According to further features in preferred embodiments of the invention described below, the router executes a decision algorithm for applying the at least one selection parameter.

According to still further features in the described preferred embodiments the at least one selection parameter is selected from the group consisting of a type of the communication data, a time of routing the communication data and a source of the communication data.

According to still further features in the described preferred embodiments the plurality of communication channel types include a telephone communication channel, a cellular communication channel, a satellite communication channel and an IP (Internet Protocol) communication channel.

According to still further features in the described preferred embodiments the router stores information relating to communication history, preferences relating to a user of the system, availability for communication of each of the plurality of communication charnel types and/or terms and conditions associated with each of the plurality of communication channel types.

According to still further features in the described preferred embodiments the system further comprises at least one user client being in communication with the router, the at least one user client being for sending and/or receiving the communication data.

According to still further features in the described preferred embodiments the at least one user client is capable of wireless communication with the router.

According to still further features in the described preferred embodiments the router includes ports for communicating with each of the plurality of communication channel types.

According to still further features in the described preferred embodiments the at least one user client is a handset unit.

According to still further features in the described preferred embodiments the router is capable of automatically establishing voice communication between two different communication channel types.

According to still further features in the described preferred embodiments the router is capable of automatically establishing communication between a first user client having IP communication capabilities and a second user client having cellular communication capabilities.

According to still further features in the described preferred embodiments the first user client is a computer and the second user client is a telephone, e.g., a cordless phone.

According to still further features in the described preferred embodiments the router is further capable of transforming a first type of data to a second type of data.

According to still further features in the described preferred embodiments the first type of data is textual data and the second type of data is voice.

According to still further features in the described preferred embodiments the communication data includes video and audio data and whereas the router is capable of splitting the communication data into separate video and audio streams.

According to still further features in the described preferred embodiments the router is capable of routing each of the video and audio streams to a specific user client or device connected thereto. For example, the router is capable of routing a demultiplexed (split) video-audio stream into a handset (audio) and a television set (video).

According to still further features in the described preferred embodiments the router is further capable of combining communication data from a plurality of communication data channels into a single data stream.

According to still further features in the described preferred embodiments the communication data includes separate video and audio data streams and whereas the router is capable of combining the separate video and audio data streams into a combined video and audio stream.

According to another aspect of the present invention there is provided a method of establishing data communication between user clients comprising: (a) analyzing communication data received from a first user client according to at least one parameter; and (b) routing the communication data through a communication channel of a plurality of communication channel types to a second user client thereby establishing data communication between the first and the second user clients, the communication channel being selected according to the at least one selection parameter.

According to still further features in the described preferred embodiments the analyzing is effected by a decision algorithm according to the at least one selection parameter.

According to still further features in the described preferred embodiments the at least one selection parameter is selected from the group consisting of a type of the communication data, a time of routing the communication data and a source of the communication data.

According to still further features in the described preferred embodiments the plurality of communication channel types include a telephone communication channel, a cellular communication channel, a satellite communication channel and an IP communication channel.

According to still further features in the described preferred embodiments the analyzing takes into account information relating to communication history, preferences relating to a user of the first or the second user client, availability for communication of each of the plurality of communication channel types and/or terms and conditions associated with each of the plurality of communication channel types.

According to still further features in the described preferred embodiments the routing automatically establishes voice communication between two different communication channel types.

According to still further features in the described preferred embodiments the first user client is an IP communication device and the second user client is a cellular communication device.

According to still further features in the described preferred embodiments the first user client is a computer and the second user client is a telephone.

According to still further features in the described preferred embodiments the router is further capable of transforming a first type of data to a second type of data.

According to still further features in the described preferred embodiments the first type of data is textual data and the second type of data is voice.

The present invention successfully addresses the shortcomings of the presently known configurations by providing a system and method for automatically routing incoming and outgoing communications through one of several communication channel types according to preferences stored by the system.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a box diagram illustrating the various functional components of the router and handset devices of the system of the present invention.

FIG. 2 is a flow chart diagram illustrating incoming phone call routing as effected by the decision making algorithm of the system of the present invention.

FIG. 3 is a flow chart diagram illustrating outgoing phone call routing as effected by the decision making algorithm of the system of the present invention.

FIG. 4 is a flow chart diagram illustrating incoming phone call processing as effected by the decision making algorithm of the system of the present invention.

FIG. 5 is a flow chart diagram illustrating outgoing phone call routing as effected by the decision making algorithm of the system of the present invention.

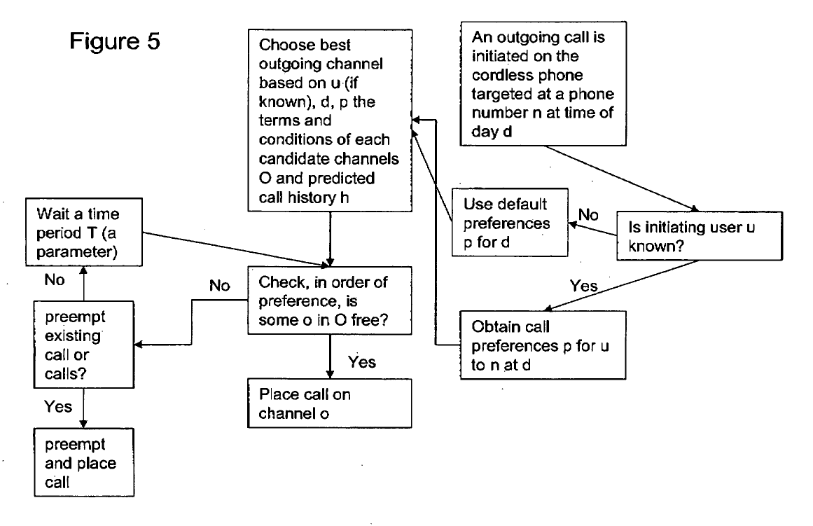

### DESCRIPTION OF THE PREFERRED EMBODIMENTS

The present invention is of a system and method which can be used to route incoming or outgoing data communication (e.g., voice communication) through a specific communication channel type and to or from a specific communications device.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Whereas a decade ago, most personal communication was conducted through landline telephones, in today's rapidly evolving communications universe, individuals regularly communicate through cellular as well as computer networks. Reliance on such networks as well as on landline telephones as information exchanges requires that users employ several communication devices each dedicated to a specific communication channel type.

Although several solutions to such device multiplicity are offered today [see, for example, the Skype Dualphone www.skype.com/products/; the Motorola SD500 cordless phone system www.motorola.com/content/0,,5444,00.html; Cidav's router www.cidavdigital.com; and the FastForward service provided by CINGULAR], none provide an end-user device which is capable of automatically selecting the most suitable communication channel from several available communication channels according to user preferences and needs, especially when more than two different channel types are utilized for communication.

Thus, according to one aspect of the present invention, there is provided a system for establishing data communication between user clients.

As used herein, the phrase “data communication” refers to any type of communication (one or two way) including voice, video, text, in either an analog or a digital format.

As used herein, the phrase “user client” refers to any device operated by a user and capable of receiving and/or sending communication data. Examples of user clients includes, but are not limited to, phones (handsets capable of communicating through cellular, landline, satellite or IP networks), personal computers, personal digital assistants (PDAs), mobile game consoles (e.g., Nintendo DS or PSP as well as the Microsoft Xbox™, the Sony Playstation™ and the Nintendo Gamecube™).

The system of the present invention includes a router device which is capable of automatically routing communication data through a communication channel of a plurality of communication channel types. As is further described below, the router device of the present invention is connected (through wired or wireless connections) to each of the plurality of communication channel types.

Communication channels are typed according to the communication network utilized. Any wired or wireless communication channel/network can be utilized by the system of the present invention including landline communication networks, cellular communication networks, satellite communication networks, cable communication networks, computer networks (including wireless networks such as, WiFi, WiMax and the like), short range communication networks (e.g., Bluetooth and other RF networks), as well as home communication networks utilized by cordless handsets.

To enable routing of incoming or outgoing communication through the appropriate communication channel, the router device of the present invention employs a decision making unit which applies one or more selection parameters throughout a decision making process to enable selection of the most appropriate communication channel type utilized.

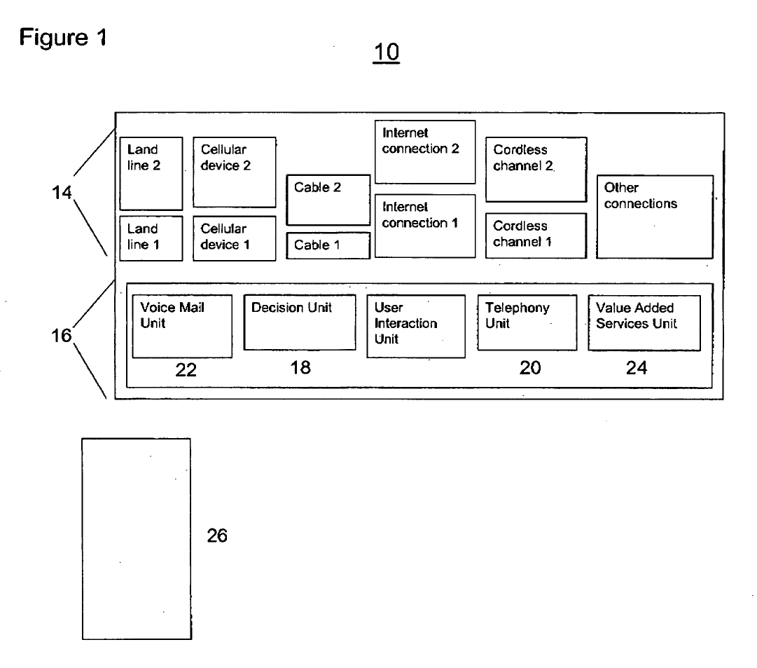

FIG. 1 illustrates the system of the present invention which is referred to herein as system 10.

System 10 includes a router 12 which includes the ports and communication channel drivers (indicated by 14) necessary for communicating through the various communications channel types. FIG. 1 illustrates 2 such ports/drivers for each network, although it is understood that router 12 can support any number of such connections for each network.

Router 12 further includes a decision making unit 18 for processing incoming or outgoing communication data according to at least one parameter as is further described hereinbelow. Decision making unit 18 includes a processor, such as a low power RISC processor (e.g., of the ARM series available from Arm Inc. www.arm.com/products) which executes a decision making algorithm. Router 12 also includes a telephony unit 20 which handles the physical aspects of telephony, that is, connecting to a communications channel (e.g., a landline or a mobile channel), receiving an incoming call on a communication channel, rerouting a call to a communication channel (one utilized within system 10 or to an outside channel), terminating a call on a channel and placing (generating) a call through a channel. In essence, the telephony unit encompasses a number of device drivers and a control program to activate and manage connections.

Router 12 further includes a voice mail unit 22 which provides voice mail services. It may be built-in, a stand-alone unit or an external service accessible through a communications channel (e.g. one provided by a landline telephone service). Voice mail unit 22 can also incorporate call recording capabilities.

Router 12 further includes a value added services unit 24 which provides services similar to those provided by a small office home office (SOHO) PBX as well as landline and wireless Centrex (including, but not limited to the DECT standard functionality). While connecting a number of communication channels to router 12, the user can operate the base unit Centrex features as they inherit (and integrate), all channel Centrex capabilities (e.g. landline and wireless Centrex). Such a configuration features all the major functions of a PBX, allowing efficient and easy communication among different users of different devices. Such a configuration of system 10 enables a user to use a conference function on one channel while receiving an incoming call on a second and different channel; it can also provide a user with integrated and separate call accounting information for each and all the different communication channels connected to system 10.

Router 12 can be realized as any processing communications-capable device which can be used in a home or office environment. For example, router 10 can be implemented by a personal computer by simply adding any necessary ports via, for example, PCI expansion cards and providing the decision making functionality through a stored software application.

One preferred implementation of router 12 is as a dedicated stand-alone unit. A dedicated box having the ports and drivers mentioned herein as well as the processor and software needed to execute the decision making algorithm described herein can be easily realized by one of ordinary skill in the art.

Such a unit can include ports (physical and/or wireless) through which cellular phones (or any type of mobile phone), landlines as well as computer networks can be connected to the unit. To enable connection to a cellular network, users can plug their cellular phones or SIM cards into the unit.

As is mentioned hereinabove, router 12 functions in routing incoming or outgoing communications to a specific channel or device. In the case of outgoing communication, router 12 can route voice communication from a cordless handset phone to a user client of a computer network. In the case of an incoming call, router 12 can redirect a landline call to a cell network or a computer network, essentially functioning as a network independent call forwarding device. An additional important feature of router 12 is an ability to locally forward communication data recieved by one user client of one communication network (e.g., cell telephony network) to a different user client of another communication network (e.g., landline telephony network) without having to switch communication networks, simply because router 12 bridges these two (and other) networks.

Although router 12 is configured capable of routing communication to and from an existing user device, such as, for example, a cellular phone, or a cordless phone, system 10 preferably further includes a dedicated handset 26 which is capable of communicating with router 12 and thus supporting incoming and outgoing communications through any communication channel type.

An incoming communications request (e.g., incoming call to a cell number, a land line number or a user ID on a computer network, e.g., Skype ID) can be directed to handset 18 and the source of communication (whether from a cellular number, a landline number or a computer) can be identifiable via a ring type or displayed color.

Handset 18 can be utilized to establish communication (e.g., place an outgoing call) through any of the communication channel types connected to router 12. The communication channel type used for communication is determined by decision making unit 18 of router 12 according to a set of parameters further described hereinbelow and in the Examples section which follows.

Use of a single device, such as handset 26, for communication of data provides several advantages to the user. There is a single device, there is no need to look for a specific device; ring type can identify the target individual; an individual is always reachable via a single device whether the individual's cell phone number or landline number are dialed; cellular devices can be positioned for optimal reception; the amount of radiation from cellular devices is minimized, since they are not used in close proximity to a human body for placing or receiving calls; and calls which would otherwise be conducted through non-mobile devices (desktop computers) can now be placed and received in a mobile device.

The decision making algorithm is configured for performing one of two basic decision types. For incoming communications data, determine the target device, while for outgoing communications, determine through which communication channel the data should be routed/placed. Such decisions are based on a set of parameters which are generated based on individuals' preferences and communication habits (e.g. history) and the various parameters associated with the channels available for communication.

Such parameters can be entered into router 12 through a dedicated data upload port or via handset 18 during setup and at any time thereafter. In addition, some parameters, especially those related to user history can be automatically saved by router 12 during operation. Such preferences are stored in a memory device of system 10 which can form a part of router 12 or handset 26. Examples of memory devices suitable for use with system 10 include any magnetic, optical or optico-magnetic memory device.

Parameters that can be stored by router 12 can be divided into incoming communication parameters and outgoing communication parameters.

Incoming communication parameters can include the following:
(i) the types and ID of individuals using the system (a “guest” user is also possible, such a user “wanders in” and connects to the system by plugging or via another local channel); for each individual additional parameters can be specified according to preferences for device or devices to which an incoming call should be routed—local channel—(e.g. a cordless phone, a regular phone, a personal computer etc.), depending on time of day, device availability at home and/or priority level of call;
(ii) the types of communication channels that are connected to the system;
(iii) target device based on the content or type of the incoming call; for example, a call with video will be routed to a video capable device or demultiplexed—with audio routed to one channel while video to another or encrypted data is sent to a decryption capable device.
(iv) a cost schedule for incoming and outgoing calls for each communication channel divided into categories such as call rates by time of day, call rates by call volume or channel usage (e.g., airtime), call rates by target phone number, call rates by target geographical area and current special offers.

Outgoing communication parameters can include the following:
(i) preferences for external channel or channels through which outgoing communication should be initiated (e.g. cable, landline, wireless, Internet etc.), such preferences can depend on call target number, time of day, priority level of call, groups of numbers (for multi-party calls);
(ii) user preferences can also be applied for each communication (e.g. call) based on whether incoming communications should be accepted or directed to a voice mail unit, whether it should be interrupted by other incoming communication requests (e.g., incoming call), whether the communication should be recorded (alternatively, text summary is an option); for each outgoing call, call-specific parameters can also define user preference for channel (overriding existing information) on which the call should be placed, group preference-type for channel (e.g., some cellular or Internet), cost cut-off, that is, if cost is exceeded, the call is terminated (with a beep preceding cut-off) and whether this is a multi-party call.
(iii) decision on a per call basis—in which the router queries providers (e.g., telephone company) for the lowest rate they can offer for the specific call and make a decision on the fly regarding which communication channel type should be used to place the outgoing call.

The following example illustrates use of preferences in outgoing call making. Suppose a user has the following preference: if the call is initiated during the time period between 9 am-5 pm, it should preferably be placed through a cellular channel (due to high landline call cost during business hours); otherwise it should be placed through a landline channel. In addition, if the call is placed during the second half of the month and a call total minute count exceeds a predetermined amount (on the cellular channel); the call should be placed through the cellular channel irrespective of time of day. Furthermore, if the call is international the above preferences should be overridden and an IP channel should be used. Using such interrelated rules the system of the present invention is able to rank channels in order of suitability for outgoing call routing. It will be appreciated that more sophisticated rules, such as examining call patterns of previous months can also be used to determine channel choice.

The Examples section below illustrates application of such parameters in a decision making process executed by decision making unit 18 of router 12.

Thus, the present invention provides a system and method which enables seamless and transparent connection of communications devices regardless of the communications channels employed thereby. The present invention also provides a user with the convenience of sending and receiving communication data (e.g., voice data) on a universal device regardless of the number to which the call was dialed.

In addition to the functions described above, system 10 of the present invention can also be configured capable of functioning as a communications hub for a multitude of non-communication devices such as television sets and stereos in the home and printers and scanners in the home office or office environment. In such a configuration, system 10 can route communication data to handset 26, as well as to a television set in the case of video or images, a stereo system in the case of voice data or to printers in the case of text and or image data. Activation of such ‘secondary’ routing can be effected by the user according to the data received thereby in handset 26 or it can be effected according to predetermined preferences stored on router 12.

The latter case is exemplified by a situation in which router 12 detects a combined video/audio communications data and splits routing of such data to two or more devices. For example, an incoming video/voice data communication can be split to handset 26 and a television screen connected to router 12 (via for example, a DVI or RGB hardwire connection) such that the user receives audio to handset 26 and is able to simultaneously view video data on the television set. Such splitting is possible by filtering out the video component to obtain pure audio component or the other way around (eliminating audio only). Since video and audio communications utilize standardized video and audio compression codecs (encoders/decoders), splitting of incoming communications streams into their audio and video components can be achieved in real-time. For example, industry standard compression codecs such as MPEG-2 or MPEG-4 can be parsed and split (demultiplexed) into separate video and audio tracks which can then be converted into a format suitable for use in a specific target device. Router 12 can also combine or co-route separate data streams from separate communication channels such that they are simultaneously displayed on one device. For example, separate audio and textual stream can be combined (or co-routed) and co-displayed on handset 26 providing the user with information from two separate sources simultaneously.

Multiplexing/demultiplexing (demux) applications suitable for splitting communication streams are well known in the art and as such no further description of such applications is provided herein.

System 10 can also be configured capable of transforming one type of data to another. For example, textual data received through a computer network channel can be converted into voice data (using a text-to-speech algorithm, e.g., CoolSpeech™ or TextSound™) and routed to handset 26 or to voice mail unit 22.

The following description illustrates use of system 10 of the present invention in typical incoming as well as outgoing communication routing scenarios.

In one scenario, router 12 is connected to two communication channels—a landline and a cellular phone. A call coming in through the landline channel or the cellular channel is routed directly to handset 26 without channel rerouting (switching).

Using the above described router, a call coming in through the cellular channel or the landline channel while handset 26 is in use can signal call waiting in handset 26 in which case, user can take the call or it can be routed to the integrated voice messaging unit or to the landline voice messaging unit. Alternatively, such a call can be routed to the respective user client or to the next available user client as pre-defined by the user.

The above describes a scenario in which there is only a single handset 26 connected to router 12. However, in cases where there are several handsets 26 connected to the router over separate channels, incoming calls can be routed to any number of handsets (each on a dedicated channel). As one of the handset accept a call, router 12 can route other incoming calls through the other channel to other handsets 26.

The above described router 12 configuration is used in outgoing call scenarios as follows: a user wanting to place a call selects a channel, for example, a landline and dials a phone number. Router 12 transfers the dialing commands to the selected channel and the call is placed. Alternatively, a call made on one communication channel type (e.g., cellular) can be routed through the landline channel.

In a case where several handsets 26 are connected to router 12, several outgoing calls can be generated simulatneuously through several separate communication channel types. Router 12 decides which channel is used for which outgoing call based on the call and user preferences.

The above described router 12 configuration can also handle an incoming/outgoing call situation. A call coming in through a cellular channel is directed (without rerouting, i.e. switching to another communication channel type) to the router handset. While the call is in progress, the user places the call on hold and creates an outgoing call. Router 12 selects the best/available outgoing communication channel, e.g., the landline channel and dials the number on that channel, at the same time, the call placed on hold can resume or be kept on hold. Once the outgoing call is established, it can be carried out through handset 26, the user can then place the incoming call on hold again (if previously resumed) and conduct the outgoing call.

It is expected that during the life of this patent many relevant communication channel types will be developed and the scope of the term communication channel type is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions; illustrate the invention in a non limiting fashion.

### Example 1

### Routing of Incoming Calls

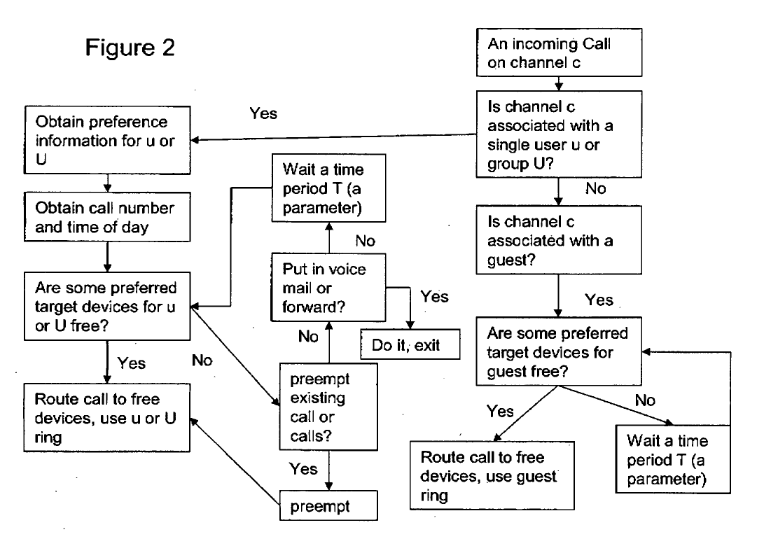

FIG. 2 is a flow chart diagram illustrating incoming phone call routing to a universal handset as effected by the decision making algorithm of the system of the present invention.

An incoming call on communication channel C is associated with (1) a single user u, (2) a group of users U, or (3) with a guest. In case (3), guest, a collection of target devices for guests is checked (these are pre-specified). If such a target device is not busy, the call is routed to the device. Otherwise, the system waits for a pre-set time period T and then retries to locate a free device. In case (1) and (2), preference information for u or U is obtained. (*) In addition, call characteristic parameters as well as current time of day values are obtained. Based on these characteristics and values, a check is made as to whether a preferred target device is free. If a free target device is found, the call is routed to the device. Upon routing, a dedicated ring tone identifying u or U, is employed. If there is no free target device and the characteristics indicate preempting another call, preemption is performed and the call is routed to the target device. Otherwise, according to characteristics, the call may be forwarded out (through another channel) or rerouted to voice mail (local or at a service provider). Otherwise, the system waits for a time period T and then retries at point (*).

The decision unit can handle a several such incoming calls simultaneously by executing the decision making process illustrated in FIG. 2 on each such incoming call. Such simultaneous processing can be realized by employing threads, tasks and/or mutual exclusion techniques (for example, semaphores or locks) to prevent several processes from simultaneously attempting to access the same resources.

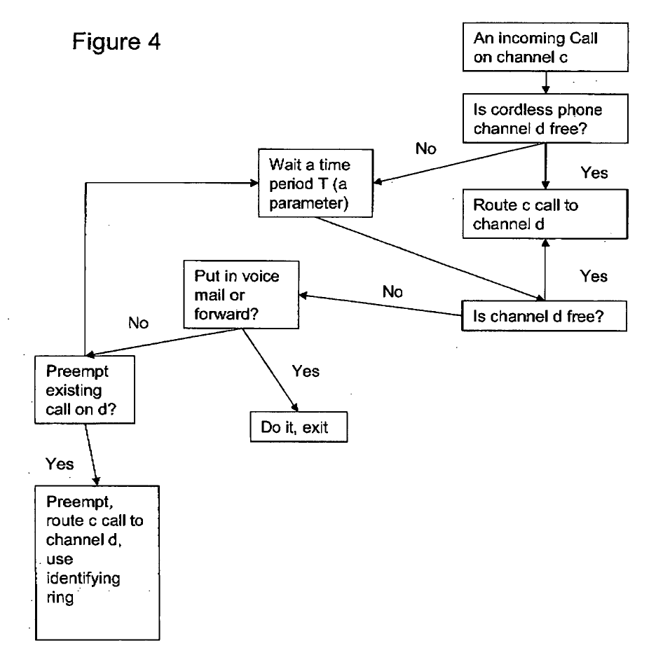

FIG. 4 presents a configuration of a system which incorporates any number of communication channel types while employing a single cordless phone on channel e as target device. An incoming call is routed to channel e when free. If channel e is in use, an incoming call is held for a period T, following which, availability of channel e is again checked. If free, the call is routed to channel e. Otherwise, based on system pre-set parameters, the system may (1) forward the call to voice mail (local or at a provider), (2) forward it to some outgoing channel, (3) preempt the existing call on channel e and route this call onto channel e.

### Example 2

### Routing of Outgoing Calls

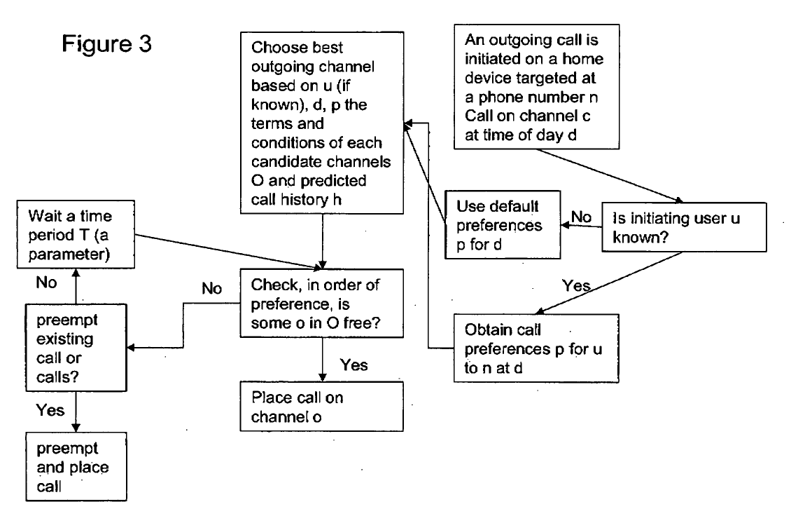

FIG. 3 is a flow chart diagram illustrating outgoing phone call routing as effected by the system of the present invention.

An outgoing call is initiated by user u through a home device (e.g., landline telephone handset), which is connected via channel c, to a phone number n at time of day d. If u is known then u's preferences p is obtained, otherwise default preferences are used. Next based on preferences p, time of day d, call history h and characteristics, terms and conditions associated with each outgoing candidate channel for placing the call, a channel o1, o2, . . . , oN in order of decreasing preferences is determined. (**) The system scans for the first free channel starting with o1, o2 and so on. If a channel is found, the call is placed through this channel. Otherwise, the system decides based on p and system parameters whether the current call conducted through the busy channel should be preempted. If the decision is to preempt, the system performs preemption of the call (by for example, transferring the existing call to another channel) and thus frees the channel for use. Otherwise, the system waits for a period T, and proceeds to (**).

In the above described example, the system of the present invention utilizes precompiled tables to quickly decide through which channel an outgoing call should be placed.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for establishing data communication between user clients comprising a router capable of automatically routing communication data through a communication channel of a plurality of communication channel types, said communication channel being selected by said router according to at least one selection parameter applied thereby.

2. The system of claim 1, wherein said router executes a decision algorithm for applying said at least one selection parameter.

3. The system of claim 1, wherein said at least one selection parameter is selected from the group consisting of a type of said communication data, a time of routing said communication data and a source of said communication data.

4. The system of claim 1, wherein said plurality of communication channel types include a telephone communication channel, a cellular communication channel, a satellite communication channel and an IP communication channel.

5. The system of claim 1, wherein said router stores information relating to communication history, preferences relating to a user of the system, availability for communication of each of said plurality of communication channel types and/or terms and conditions associated with each of said plurality of communication channel types.

6. The system of claim 1, further comprising at least one user client being in communication with said router, said at least one user client being for sending and/or receiving said communication data.

7. The system of claim 6, wherein said at least one user client is capable of wireless communication with said router.

8. The system of claim 1, wherein said router includes ports for communicating with each of said plurality of communication channel types.

9. The system of claim 6, wherein said at least one user client is a handset unit.

10. The system of claim 1, wherein said router is capable of automatically establishing voice communication between two different communication channel types.

11. The system of claim 1, wherein said router is capable of automatically establishing communication between a first user client having IP communication capabilities and a second user client having cellular communication capabilities.

12. The system of claim 11, wherein said first user client is a computer and said second user client is a telephone.

13. The system of claim 1, wherein said router is further capable of converting a first type of data to a second type of data.

14. The system of claim 13, wherein said first type of data is textual data and said second type of data is voice.

15. The system of claim 1, wherein said router is further capable of splitting said communication data into a plurality of communication data streams.

16. The system of claim 15, wherein said communication data includes video and audio data and whereas said router is capable of splitting said communication data into separate video and audio streams.

17. The system of claim 16, wherein said router is capable of routing each of said video and audio streams to a specific user client or device connected thereto.

18. A method of establishing data communication between user clients comprising:
(a) analyzing communication data received from a first user client according to at least one parameter; and
(b) routing said communication data through a communication channel of a plurality of communication channel types to a second user client thereby establishing data communication between said first and said second user clients, said communication channel being selected according to said at least one selection parameter.

19. The method of claim 18, wherein said analyzing is effected by a decision algorithm according to said at least one selection parameter.

20. The method of claim 18, wherein said at least one selection parameter is selected from the group consisting of a type of said communication data, a time of routing said communication data and a source of said communication data.

21. The method of claim 18, wherein said plurality of communication channel types include a telephone Do we have to say what kind of telephone, landline? Cellular? Communication channel, a cellular communication channel, a satellite communication channel and an IP communication channel.

22. The method of claim 18, wherein said analyzing takes into account information relating to communication history, preferences relating to a user of said first or said second user client, availability for communication of each of said plurality of communication channel types and/or terms and conditions associated with each of said plurality of communication channel types.

23. The method of claim 18, wherein said routing automatically establishes voice communication between two different communication channel types.

24. The method of claim 18, wherein said first user client is an IP communication device and said second user client is a cellular communication device.

25. The method of claim 24, wherein said first user client is a computer and said second user client is a telephone.

26. The method of claim 18, wherein said router is further capable of transforming a first type of data to a second type of data.

27. The method of claim 26, wherein said first type of data is textual data and said second type of data is voice.
